(19) United States
(12) Patent Application Publication
(10) Pub. No.: US 2012/0031098 A1
(43) Pub. Date: Feb. 9, 2012

(54) FUEL NOZZLE WITH CENTRAL BODY COOLING SYSTEM

(76) Inventors: Leonid Ginessin, Moscow (RU); Borys Shershnyov, Moscow (RU); Almaz Valeev, Moscow (RU)

(21) Appl. No.: 13/196,968

(22) Filed: Aug. 3, 2011

(30) Foreign Application Priority Data
Aug. 3, 2010 (RU) 2010132334

(51) Int. Cl. F02C 7/12

(52) U.S. Cl. 60/740

(57) ABSTRACT

A fuel nozzle for turbine engine includes a cooling shroud located at the downstream end of the fuel nozzle to help cool the downstream end of the fuel nozzle. The cooling shroud surrounds the exterior circumference of the downstream end of the fuel nozzle. A flow of air is admitted into the cooling shroud and the flow of air travels in the downstream direction through a first passageway which covers the exterior of the fuel nozzle. The cooling air flow then turns 180° and travels in the upstream direction through a second passageway which is located concentrically outside the first passageway. The airflow then leaves the upstream end of the cooling shroud and enters the interior of the fuel nozzle.

### BACKGROUND OF THE INVENTION

1. Field of the Invention

In general, the field of invention relates to fuel nozzles which are used in combustors of turbine engines.

2. Description of Related Art

Typically, a plurality of fuel nozzles will be mounted on a combustor cap located at the upstream end of the combustor. The fuel nozzles will deliver fuel into a flow of compressed air to create a fuel-air mixture which is then burned in the combustor.

Because the fuel nozzles are located just upstream of the location where the fuel-air mixture is burned, the outer surfaces and downstream ends of the fuel nozzles are subjected to high temperature combustion products. These high temperatures can damage the fuel nozzles

### BRIEF SUMMARY OF THE INVENTION

According one embodiment of the present invention, there is provided a fuel nozzle for a turbine engine comprising: a generally cylindrical shaped outer housing; a cylindrical shaped cooling shroud that concentrically surrounds a downstream portion of an exterior of the outer housing. The cooling shroud comprises: a cylindrical shaped outer wall; a downstream end wall that joins a downstream end of the outer wall to the downstream end of the outer housing; and a cylindrical shaped dividing wall positioned concentrically between the outer wall of the cooling shroud and the exterior of the outer housing, wherein a gap is exists between a downstream end of the dividing wall and the downstream end wall of the cooling shroud. A plurality of air inlets are located at the upstream side of the cooling shroud, wherein the air inlets admit a flow of cooling air into an annular space between the exterior surface of the outer housing and an inner surface of the dividing wall. The cooling air flow travels in a downstream direction to a downstream end of the cooling shroud, turns 180° around the downstream end of the dividing wall and enters an annular space between the outer surface of the dividing wall and an inner surface of the outer wall of the cooling shroud. The flow of cooling air then travels in an upstream direction to an upstream end of the cooling shroud. A plurality of air outlets are located at the upstream end of the cooling shroud, and the air outlets direct the flow of cooling air from the annular space between the outer surface of the dividing wall and the inner surface of the outer wall into a space located inside the outer housing of the fuel nozzle.

According to another embodiment of the present invention, there is provided cooling shroud for cooling an exterior of a cylindrical fuel nozzle of the turbine engine comprising: a generally cylindrical outer wall; a downstream end wall configured to join a downstream end of the outer wall to a downstream end of the outer housing of a fuel nozzle, and a generally cylindrical shaped dividing wall. The dividing wall is positioned concentrically inside the outer wall, and the dividing wall is configured to be located between the outer wall of the cooling shroud and the outer housing of a fuel nozzle. A gap is maintained between a downstream end of the dividing wall and the downstream end wall of the cooling shroud. A plurality of air inlets are located at the upstream side of the cooling shroud such that when the cooling shroud is mounted onto a fuel nozzle, the air inlets admit a flow of cooling air into an annular space between an outer housing of the fuel nozzle and an inner surface of the dividing wall. In addition, a plurality of air outlets are located at the upstream end of the cooling shroud. When the cooling shroud is mounted on a fuel nozzle, the air outlets direct a flow of cooling air from an annular space between the outer surface of the dividing wall and an inner surface of the outer wall of the cooling shroud into openings in the outer housing of the fuel nozzle.

### BRIEF DESCRIPTION OF THE SEVERAL VIEWS OF THE DRAWINGS

FIG. 1 is a cross-sectional view of a fuel nozzle for a turbine engine which includes a cooling shroud;

FIG. 2 is a cross-sectional view of he downstream end of a fuel nozzle with a cooling shroud;

FIG. 3 is a cross-sectional view of the downstream end of a fuel nozzle with a cooling shroud;

FIG. 4 is a perspective cross-sectional view illustrating the downstream end of a cooling nozzle with a cooling shroud;

FIG. 5 is a perspective cross-sectional view illustrating the downstream end of a fuel nozzle with a cooling shroud;

FIG. 6 is a perspective cross-sectional view of the downstream end of a fuel nozzle with a cooling shroud;

FIG. 7 is a perspective cross-sectional view of the downstream end of a fuel nozzle with a cooling shroud;

FIG. 8 is a perspective view illustrating the air inlets and air outlets of a cooling shroud of a fuel nozzle;

FIG. 9 is a perspective cross-sectional view illustrating how air enters the air inlets of a cooling shroud of a fuel nozzle; and

FIG. 10 is a perspective cross-sectional view illustrating how the cooling air outlets of a cooling shroud direct cooling air out of the cooling shroud and into the fuel nozzle.

### DETAILED DESCRIPTION OF THE INVENTION

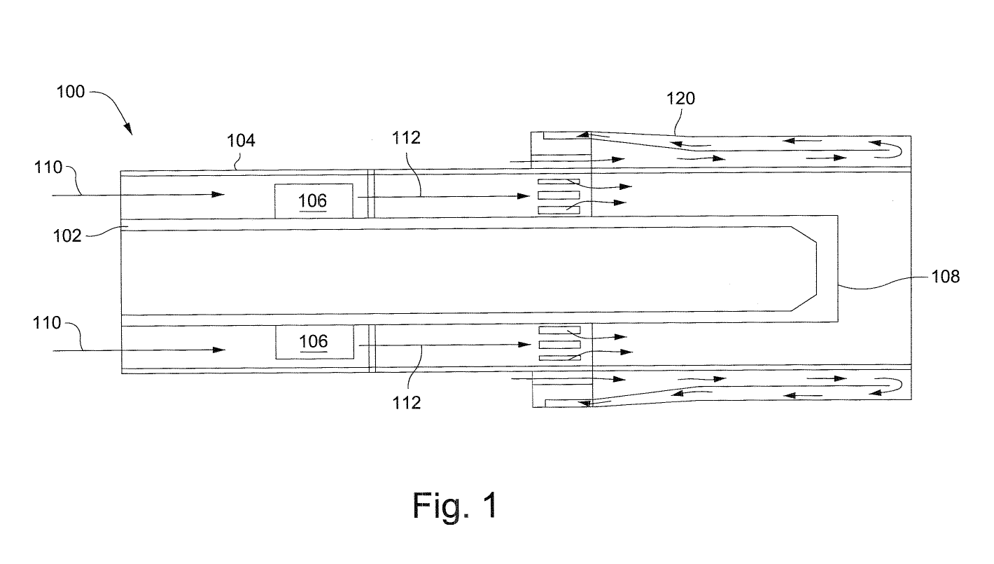

A fuel nozzle for use in a turbine engine which includes a cooling shroud is illustrated in FIG. 1. As shown therein, the fuel nozzle includes a generally cylindrical central nozzle section 102 which is located inside an outer housing 104. A flow of air indicated by arrows 110 enters the upstream end of the fuel nozzle. The air entering the fuel nozzle travels through an annular space located between the outer wall of the central nozzle section 102 and an inner wall of the outer housing 104. The flow of air passes fuel vanes 106 which deliver fuel into the flow of air. The fuel vanes 106 may also be angled with respect to the longitudinal axis of the nozzle, which causes the air and fuel mixture to swirl within the fuel nozzle, and this swirling can help of mix the fuel and the air.

Once fuel has been delivered into the air, the fuel-air mixture, which is indicated by arrows 112, continues to pass in a downstream direction through the annular space between the outside of the central nozzle section 102 and the inner wall of the outer housing 104. The fuel-air mixture then ultimately exits the downstream end of the fuel nozzle.

A similar fuel-air mixture may also pass down the central portion of the central nozzle section 102 and exit a tip 108 of the central nozzle section 102. This fuel-air mixture will then also exit the downstream end of the fuel nozzle.

Typically, the fuel-air mixture will be burned just downstream of the fuel nozzle. In addition, in some combustors, adjacent fuel nozzles can be located at different positions along the length of the combustor. As a result, a first fuel nozzle located further upstream than a second fuel nozzle can create a flame that is immediately adjacent the exterior of the second downstream nozzle. As a result, the outer sides and downstream ends of the fuel nozzles are subjected to extremely high operating temperatures. For these reasons, it is desirable to cool the outer sides and at least the downstream end of the fuel nozzle to help prevent the fuel nozzle from being damaged by the high combustion temperatures.

FIG. 1 illustrates that a cooling shroud 120 is mounted around a downstream end of the fuel nozzle 100. As will be explained in greater detail below, the cooling shroud acts to circulate a flow of cool air around the exterior of the downstream end of the fuel nozzle. The cooling airflow is ultimately delivered into the interior of the outer housing 104. As a result, the flow of air used to cool the end of the nozzle ultimately joins the fuel-air mixture passing down the annular space between the outer side of the central nozzle section and the inner side of the outer housing.

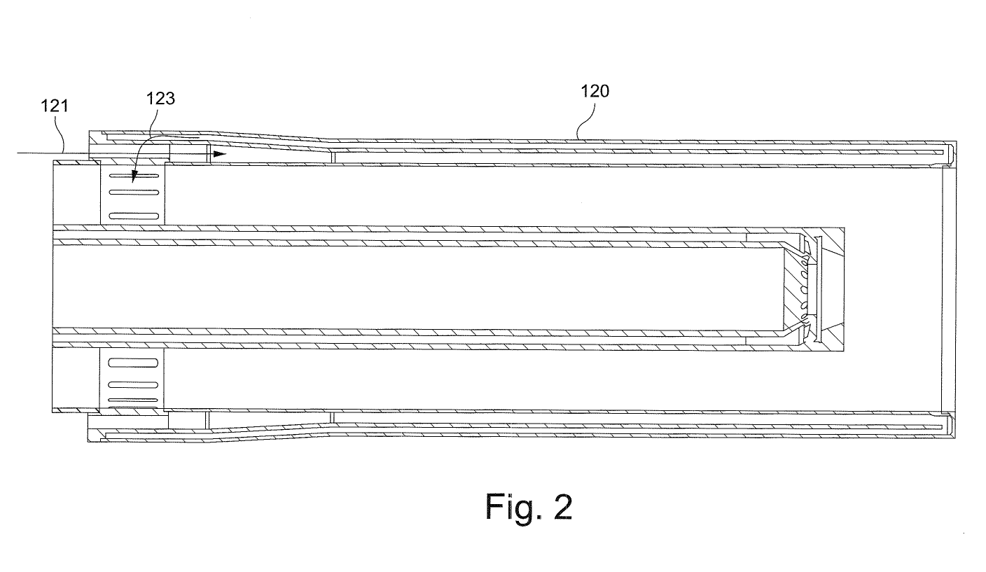

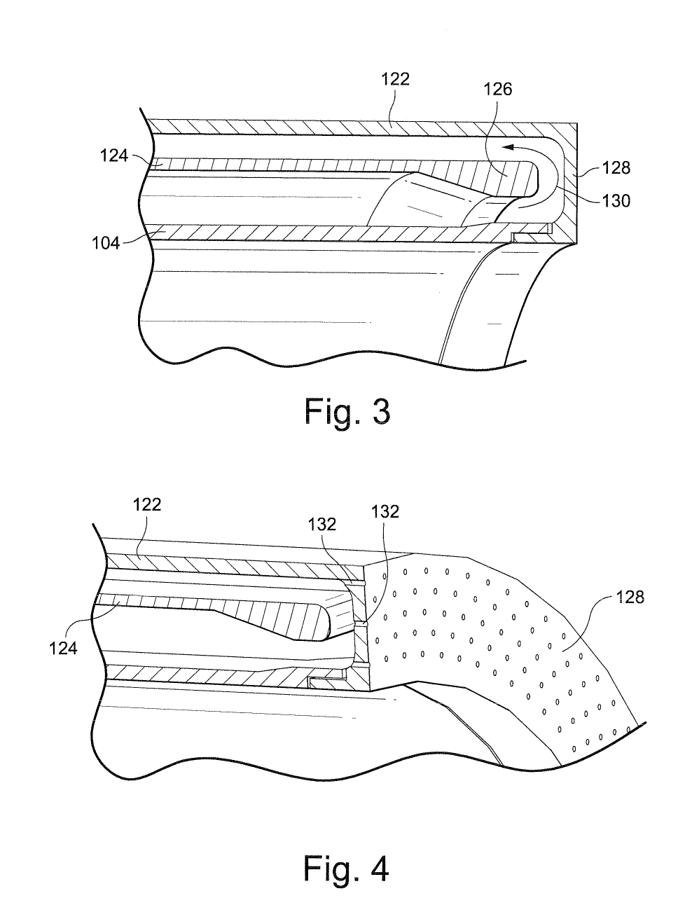

FIG. 2 shows an enlarged view of downstream end of a fuel nozzle where a cooling shroud 120 is mounted around the exterior of the downstream end of the fuel nozzle. FIG. 3 provides an enlarged view of the downstream end of the fuel nozzle, including the cooling shroud.

As illustrated in FIGS. 2 and 3, the cooling shroud includes an outer wall 122 and a dividing wall 124. The dividing wall 124 is positioned concentrically inside the outer wall 122. As a result, the dividing wall 124 is positioned between the outer housing 104 of the fuel nozzle and the outer wall 122 of the cooling shroud. Also, an end wall 128 of the cooling shroud 120 is joined to the end of the outer wall 104 of the fuel nozzle.

At the upstream end of the cooling shroud 120, a plurality of air inlets admit a flow of air which passes down the length of the exterior of the fuel nozzle. This flow of cooling air is illustrated by arrow 121 in FIG. 2.

The flow of cooling air passes through the air inlets of the cooling shroud and into an annular space located between the exterior surface of the outer housing 104 of the fuel nozzle and an inner surface of the dividing wall 124. The cooling air passes down the length of the exterior of the fuel nozzle to help cool the downstream end of the fuel nozzle. As illustrated in FIG. 3, the flow of cooling air reaches the downstream end of the cooling shroud and turns 180° around the downstream edge of the dividing wall 124. This flow of cooling air is identified by the arrow 130 appearing in FIG. 3.

The flowing of cooling air then passes in the upstream direction along an annular space between the outer surface of the dividing wall 124 and an inner surface of the outer wall 122 of the cooling shroud. The flow of cooling air travels in the upstream direction to the upstream end of the cooling shroud.

The flow of cooling air which has traveled back to the upstream end of the cooling shroud then turns 90° and passes through air outlets of the cooling shroud into an interior of the fuel nozzle. This flow of cooling air is illustrated with the arrow identified with reference numeral 123 in FIG. 2. The flow of cooling air then mixes with the air-fuel mixture located within the fuel nozzle. Thus, the air used to cool the downstream end of the nozzle ultimately exits the downstream end of the fuel nozzle where it is burned in the combustor.

As illustrated in FIG. 3, in some embodiments the downstream end of the dividing wall 124 may include an enlarged portion 126. This enlarged portion may be rounded, as illustrated in FIG. 3. The enlarged, rounded end portion 126 accelerates the flow speed of the air flow as the air makes a 180° turn at the downstream end of the cooling shroud. The increased flow speed helps to increase the efficiency of the cooling provided by the flow of air at the downstream end of the cooling shroud.

As illustrated in FIG. 4, a plurality of effusion cooling holes 132 can be located in the end wall 128 of the cooling shroud 120. The effusion cooling holes 132 would allow a small portion of the cooling airflow to escape from an interior of the cooling shroud to an exterior of the cooling shroud. This effusion cooling would help to cool the downstream end wall 128 of the cooling shroud.

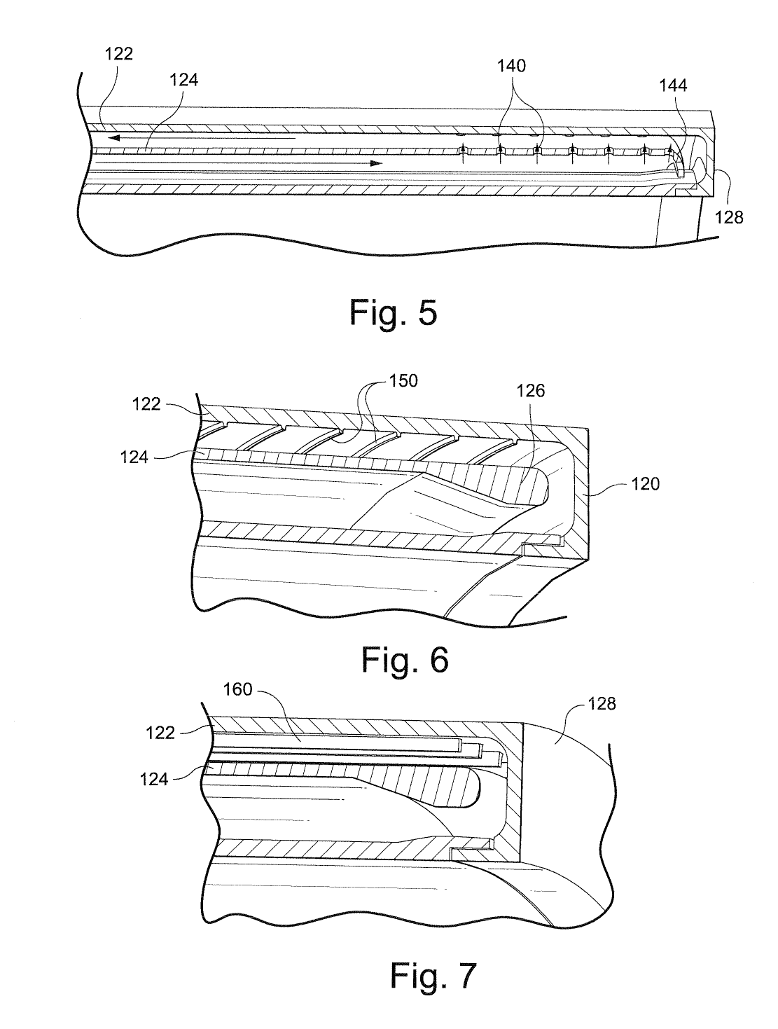

As illustrated in FIG. 5, in some embodiments the dividing wall 124 may include a plurality of impingement cooling holes 140. The impingement cooling holes 140 would allow the flow of cooling air located between the exterior surface of the outer housing 104 and the inner surface of the dividing wall 124 to pass through the impingement cooling holes 140 and into the annular space between the outer surface of the dividing wall 124 and the inner surface of the outer wall 122 of the cooling shroud.

In embodiments which include the impingement cooling holes 140, the downstream end of the dividing wall 124 may include a curved end portion 144 which turns 90° inward to join the outer wall 104 of the fuel nozzle. The impingement cooling holes 140 in this curved end portion 144 of the dividing wall 124 may also help to direct the flow of cooling air against the inside of the end wall 128 of the cooling shroud to help cool the end wall 128.

In some embodiments, projections may be formed on the inner side of the outer wall 122 of the cooling shroud. For instance, FIG. 6 illustrates an embodiment where a plurality of ring shaped projections 150 are located on the inside of the outer wall 122 of the cooling shroud. The ring shaped projections 150 would be formed around the circumference of the inner side of the outer wall 122. These ring shaped projections 150 would help to induce turbulence in the flow of cooling air, which may lead to a greater cooling effect.

In the embodiment illustrated in FIG. 7, a plurality of projections 160 are also formed on the inside of the outer wall 122 of the cooling shroud. However, these projections 160 extend in the longitudinal direction to help guide the flow of cooling air toward the upstream end of the cooling shroud. The projections 160 may also act as cooling fins to help increase the cooling effect provided by the flow of cooling air.

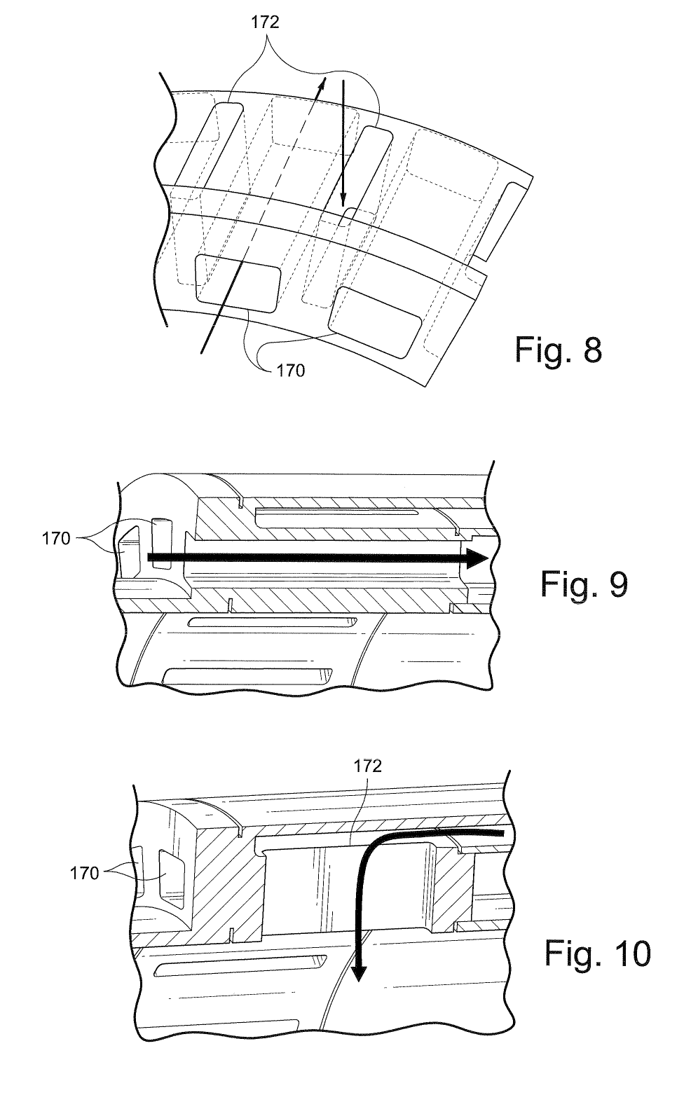

The air inlets and air outlets located at the upstream end of the cooling shroud are illustrated in greater detail in FIGS. 8-10. The air inlets 170 would extend in the longitudinal direction of the fuel nozzle and the cooling shroud. The air inlets 170 would act to emit a flow of air which is passing down the exterior of the fuel nozzle into the annular space located between the exterior surface of the outer housing 104 of the fuel nozzle and an inner surface of the dividing wall 124 of the cooling shroud. FIG. 9 is a perspective sectional view which provides another view of the air inlets 170 which emit air into the cooling shroud.

The air outlets 172 act to convey a flow of cooling air from the annular space between the outer surface of the dividing wall 124 and the inner surface of the outer wall 122 of the cooling shroud into a space located inside the outer housing 104 of the fuel nozzle. Thus, the air outlets would generally extend in a radial direction toward the inside of the fuel nozzle. FIG. 10 provides another illustration of how the air outlets 172 convey air down to the interior of the fuel nozzle.

In some embodiments, each air inlet 170 would be located between a pair of adjacent air outlets 172. Thus, the air inlets 170 and air outlets 172 alternate with one another around the exterior circumference of the cooling shroud.

In some embodiments, the air outlets 172 would extend in the radial direction from the annular space between the outer surface of the dividing wall 124 and the inner surface of the outer wall 122 of the cooling shroud. In other alternate embodiments, a central axis of the air outlets is angled with respect to the radial direction. In this instance, the air exiting the cooling shroud through the air outlets 172 and entering the interior of the fuel nozzle would tend to swirl around the interior of the fuel nozzle. This could be advantageous in helping to mix the air and fuel present in the interior of the fuel nozzle.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A fuel nozzle for a turbine engine, comprising:
a generally cylindrical shaped outer housing;
a cylindrical shaped cooling shroud that concentrically surrounds a downstream portion of an exterior of the outer housing, wherein the cooling shroud comprises;
a cylindrical shaped outer wall;
a downstream end wall that joins a downstream end of the outer wall to a downstream end of the outer housing;
a cylindrical shaped dividing wall positioned concentrically between the outer wall of the cooling shroud and the exterior of the outer housing, wherein a gap exists between a downstream end of the dividing wall and the downstream end wall;
a plurality of air inlets located at an upstream end of the cooling shroud, wherein the plurality of air inlets admit a flow of cooling air into an annular space between the exterior surface of the outer housing and an inner surface of the dividing wall, and
a plurality of air outlets located at the upstream end of the cooling shroud, where the plurality of air outlets direct a flow of cooling air from an annular space between the outer surface of the dividing wall and an inner surface of the outer wall of the cooling shroud into a space located inside the outer housing of the fuel nozzle.

2. The fuel nozzle of claim 1, wherein the cooling shroud is configured such that a flow of cooling air that is admitted through the plurality of air inlets into the annular space between the exterior surface of the outer housing and an inner surface of the dividing wall will travel in a downstream direction to a downstream end of the cooling shroud, turn about 180° around the downstream end of the dividing wall to enter the annular space between the outer surface of the dividing wall and an inner surface of the outer wall of the cooling shroud, and flow in the upstream direction to the upstream end of the cooling shroud.

3. The fuel nozzle of claim 1, wherein a plurality of effusion cooling holes are located in the downstream end wall of the cooling shroud, and wherein cooling air located within a downstream end of the cooling shroud can pass through the plurality of effusion cooling holes to exit the cooling shroud.

4. The fuel nozzle of claim 1, wherein a downstream end of the dividing wall has an increased thickness portion with a rounded end.

5. The fuel nozzle of claim 1, wherein a plurality of impingement cooling holes are formed in a downstream portion of the dividing wall such that cooling air located in the annular space between the exterior surface of the outer housing and an inner surface of the dividing wall can pass through the plurality of impingement cooling holes to enter the annular space between the outer surface of the dividing wall and an inner surface of the outer wall of the cooling shroud.

6. The fuel nozzle of claim 5, wherein a downstream end of the dividing wall includes a curved portion that turns about 90° inward toward the exterior surface of the outer housing of the fuel nozzle, and wherein apertures are provided in the downstream end of the dividing wall such that air can flow through the apertures.

7. The fuel nozzle of claim 1, wherein projections are formed on an inner surface of the outer wall of the cooling shroud.

8. The fuel nozzle of claim 7, wherein the projections comprise projecting rings on the inner surface of the outer wall of the cooling shroud that extend around the circumference of the cooling shroud.

9. The fuel nozzle of claim 7, wherein the projections comprise projecting ridges that extend along the inner surface of the outer wall of the cooling shroud in a direction that is parallel to a longitudinal axis of the fuel nozzle.

10. The fuel nozzle of claim 1, wherein each air inlet is located between a pair of adjacent air outlets.

11. The fuel nozzle of claim 1, wherein each air outlet includes a radial passageway that extends in a generally radial direction from the annular space between the outer surface of the dividing wall and the inner surface of the outer wall of the cooling shroud to an opening in the exterior surface of the outer housing.

12. The fuel nozzle of claim 1, wherein each air outlet includes a passageway that extends from the annular space between the outer surface of the dividing wall and the inner surface of the outer wall of the cooling shroud to an opening in the exterior surface of the outer housing.

13. The fuel nozzle of claim 12, wherein a central axis of each radial passageway is angled with respect to a radial direction of the fuel nozzle such that the flow of cooling air entering the space inside the outer housing of the fuel nozzle tends to swirl around the space inside the outer housing.

14. A cooling shroud for cooling an exterior of a cylindrical fuel nozzle of a turbine engine, comprising:
a generally cylindrical outer wall;
a downstream end wall configured to join a downstream end of the outer wall to a downstream end of the outer housing of a fuel nozzle;
a generally cylindrical shaped dividing wall positioned concentrically inside the outer wall, wherein the dividing wall is configured to be located between the outer wall of the cooling shroud and the outer housing of a fuel nozzle, and wherein a gap is maintained between a downstream end of the dividing wall and the downstream end wall;
a plurality of air inlets located at an upstream side of the cooling shroud, wherein when the cooling shroud is mounted onto a fuel nozzle, the plurality of air inlets admit a flow of cooling air into an annular space between an outer housing of the fuel nozzle and an inner surface of the dividing wall; and
a plurality of air outlets located at the upstream end of the cooling shroud, where when the cooling shroud is mounted on a fuel nozzle, the plurality of air outlets direct a flow of cooling air from an annular space between the outer surface of the dividing wall and an inner surface of the outer wall of the cooling shroud into openings in the outer housing of the fuel nozzle.

15. The cooling shroud of claim 14, wherein a plurality of effusion cooling holes are located in the downstream end wall of the cooling shroud, and wherein cooling air located within a downstream end of the cooling shroud can pass through the plurality of effusion cooling holes to exit the cooling shroud.

16. The cooling shroud of claim 14, wherein the downstream end of the dividing wall has a rounded end.

17. The cooling shroud of claim 14, wherein a plurality of impingement cooling holes are formed in a downstream portion of the dividing wall such that cooling air that is located on a first side of the dividing wall can pass through the plurality of impingement cooling holes to a location on a second opposite side of the dividing wall.

18. The cooling shroud of claim 14, wherein projections are formed on an inner surface of the outer wall of the cooling shroud.

19. The cooling shroud of claim 14, wherein each air inlet is located between a pair of adjacent air outlets.

20. The cooling shroud of claim 14, wherein each air outlet includes a passageway extending inward from the annular space between the outer surface of the dividing wall and the inner surface of the outer wall of the cooling shroud, the passageway having a central axis that extends at an angle with respect to a radial direction of the cooling shroud.
